(19) United States
(12) Patent Application Publication
(10) Pub. No.: US 2007/0095613 A1
(43) Pub. Date: May 3, 2007

(54) Tree stand safety cover

(76) Inventor: Russell W. Cummings, Cave Spring, GA (US)

Correspondence Address: LITMAN LAW OFFICES, LTD., P.O. BOX 15035, CRYSTAL CITY STATION, ARLINGTON, VA, 22215, US

(21) Appl. No.: 11/260,308

(22) Filed: Oct. 28, 2005

(51) Int. Cl. A01M 31/00

(52) U.S. Cl. 182/187

(57) ABSTRACT

The tree stand safety cover is a hunters' safety device adapted to cover equipment carried on a hunter's back with a highly visible material so that the hunter is recognizable to other hunters in a hunting environment. The safety cover includes a covering body of a foldable material. A securing system, such as ties or straps, is attached to the covering body for securing the covering body over gear carried on the hunters back. The safety cover further includes a pouch into which the safety cover can be folded and stored when not in use. The safety includes an interior pocket. The safety cover is attached to an interior surface of the safety pouch pocket. The interior attachment point allows the safety cover to be stored completely within the pocket of the safety pouch without detaching the pouch from the safety cover.

### BACKGROUND OF THE INVENTION

1. Field of the Invention

The present invention relates to safety features for hunting, and in particular, to a cover for enhancing the ability of hunters carrying hunting equipment.

2. Description of the Related Art

Many people enjoy the outdoor sport of hunting. People are attracted to the sport both to actively participate in the bagging of game animals as well as to simply enjoy the outdoor environment in which the game animals live. But whether hunting or accompanying others who are hunting, people who find themselves in wooded areas in which hunting is taking place face the risk of being shot by a hunter who misidentifies them as a game animal.

Game animals are often found in heavily wooded areas. The high density of foliage in the habitat for the game animals can obscure the outlines of a person viewed at a distance resulting in a misidentification of the person as a legitimate target for a hunter. To reduce the risk of being misidentified as a game animal and subsequently being shot at by a hunter, hunters wear hunting garments of a signaling color such as a distinctive orange color known as hunter orange or blaze orange. Hunter orange is a florescent orange color with a wavelength of approximately 595 nanometers. Other colors or distinctive patterns may be employed as signaling colors. For example, hunter's garments may be comprised of camouflage patterns including a specified percentage of hunter orange interspersed with other colors. In some hunting areas, vibrant, fluorescent green colors are specified as hunters' signaling colors.

Hunters know that the presence signaling colors such as hunter orange indicates a human being and will not shoot in the direction of the human. Increasing the surface area of covered by the signaling color increases the visibility in a heavily foliaged environment and improves the safety of a person wearing the signaling colors while reducing the colored safety area increases the risk of being misidentified as game and being shot at. For that reason many jurisdictions specify a requirement surface area of visible signaling color such as hunter orange to be worn by hunters and others present in the hunting environment.

Even when outfitted with garments having a safe amount of signaling color, hunters may compromise their safety if they obscure the signaling color of their garments with objects of non-signaling colors. For example it is common for hunters to carry tree stands and hunting blinds into hunting areas. These hunting devices are often designed to be stored in a compact arrangement that a hunter can carry on his back. Carrying items on the hunters back can obscure large portions of a garment such as a hunting jacket made of an orange color. Hunters and people accompanying hunters may also be carrying gear such as tents, and cooking gear in a backpack.

One solution to the problem of obscuring of signaling colors with a backpack or back carried tree stands, is to use backpacks and tree stands which themselves are colored orange. However, it may be undesirable for a tree stand to be permanently colored orange. Once a tree stand is installed in a tree, the orange color is not required to deter being fired at by hunters who understand that large game animals such as deer will not be found in trees. Hunters are also unlikely to mistake human sized objects for game birds. Instead the highly visible, bright hunters orange or other signaling colors serves to increase the visibility of hunters to game animals, warning them away from closely approaching the hunter. Since the purpose of the tree stands and other blinds is to remove the hunter from the normal lines of sight of game animals so that the animals approach within the hunter's shooting range, the use of hunters orange for an installed tree stand is counterproductive. The signaling colored gear reduces the possibility of shooting a game animal while not appreciably contributing to the safety of the hunter.

A safety cover that could be worn over the back carried items and which could be removed when the item was being carried on the back would preserve the hunter's safety during a carrying operation. If the safety cover could additionally be securely stowed away when not needed for safety, the deterrent effect on deer could be minimized increasing the hunter's chance of shooting a game animal.

French Patent No. 2,578,281, published Sep. 5, 1986, describes a collapsible tent including a metal frame and fabric material. The described invention is illustrative of the state of the art with respect to gear that may be carried by hunters, but does not describe an invention having a similar function or structure to the instant invention.

None of the above inventions and patents, taken either singly or in combination, is seen to describe the instant invention as claimed. Thus, a tree stand safety cover solving the aforementioned problems is desired.

### SUMMARY OF THE INVENTION

The tree stand safety cover is adapted to cover equipment carried on a hunter's back with a highly visible material so that the hunter is recognizable to other hunters in the same hunting environment. The safety cover includes a covering body of a foldable material. A securing system such as ties or straps is attached to the covering body for securing the covering body over gear carried on the hunters back. The safety cover further includes a pouch into which the safety cover can be folded and stored when not in use. The safety pouch interior forms a pocket and the safety cover is attached to an interior surface of the safety pouch pocket. The interior attachment point allows the safety cover to be stored completely within the pocket of the safety pouch without detaching the pouch from the safety cover.

The safety cover pouch is provided with a means for closing the pocket. In one embodiment the closing means comprises a zippering fastener. In another embodiment, the closing means comprises a hook and loop fastening system.

The covering body of the safety cover is preferably hunter orange or other recognized signaling color that is easily visible in the hunting environment and that is recognizable to hunters as signifying the presence of a human.

The surface area of signaling color provided by the safety cover provides an effective area for signaling the presence of the hunter. The surface area may be sufficient to comply with safety regulations for hunters. For example in one embodiment, the safety cover provides an effective colored area of approximately 500 square inches.

In one embodiment, the safety cover pouch is provided with an attachment means for securing the safety cover to an object or to the person of the hunter when the safety cover is not in use. In the preferred embodiment the pouch attachment means is comprises of an eyelet open eyelet passing through the body of the pouch.

These and other features of the present invention will become readily apparent upon further review of the following specification and drawings.

### BRIEF DESCRIPTION OF THE DRAWINGS

FIG. 1 is a rear perspective view of a hunter wearing an embodiment of a tree stand safety cover according to the invention.

FIG. 2 is a front view of an unfolded tree stand safety cover according to the invention.

FIG. 3A is front perspective view of tree stand safety cover according to the invention in a partially folded condition.

FIG. 3B is a front perspective view of tree stand safety cover according to the invention folded longitudinally to fit within the width of the pouch opening.

FIG. 3C is a front perspective view of tree stand safety cover according to the invention in a fully folded into the storage pouch.

FIG. 4 is a front perspective view of an embodiment of a tree stand cover according to the invention with an alternate attachment point for a pouch.

FIG. 5 is a front perspective view of tree stand cover according to the invention stored within a closed pouch.

Similar reference characters denote corresponding features consistently throughout the attached drawings.

### DETAILED DESCRIPTION OF THE PREFERRED EMBODIMENTS

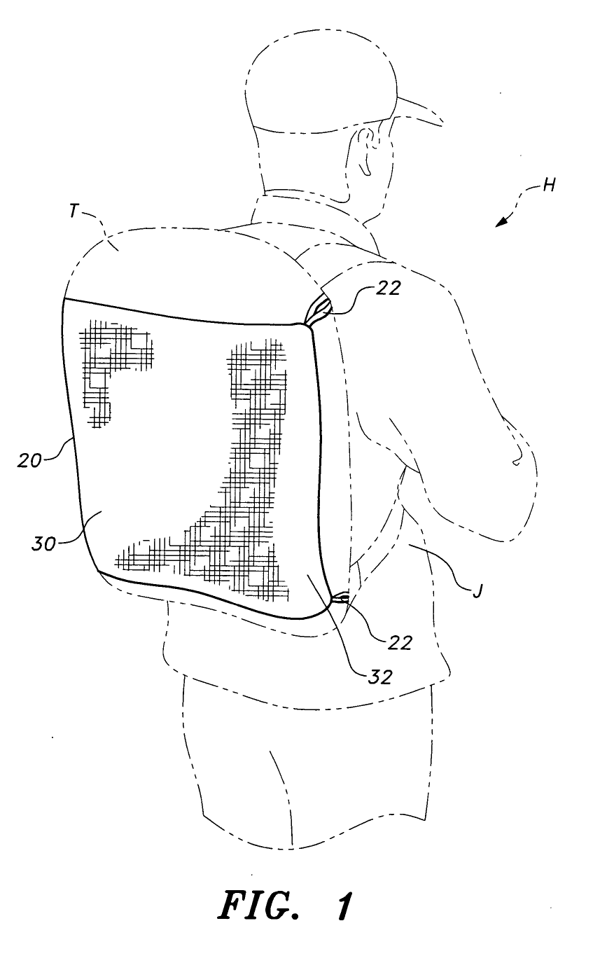

The present invention is a wearable cover intended to preserve the visibility of the wearer by covering the rear torso of the wearer as well as a backpack, tree stand or other gear carried on the back of the wearer with material of a highly visible color. Details of a safety cover in accordance with the invention may be appreciated by referring to FIGS. 1-5.

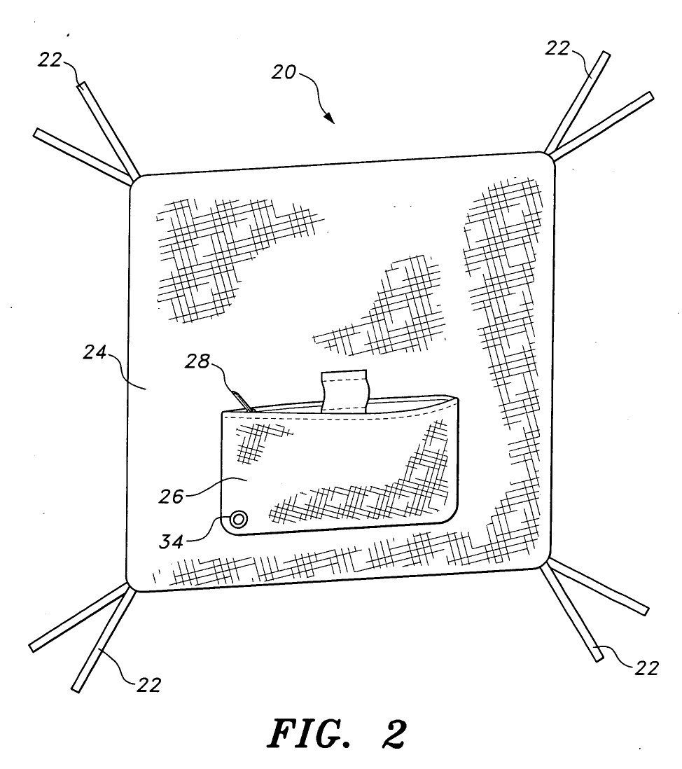

Referring first to FIGS. 1 and 2, the use of a safety cover 20 in accordance with the invention may be understood. A hunter H is shown wearing a hunting jacket J. The hunting jacket J is made of a highly visible color such as hunter orange colored material. The use of hunter orange allows the torso of the hunter H to be highly visible because of the high degree of contrast with the colors of foliage and vegetation generally present in a hunting environment. The hunter H is additionally carrying a portable tree-hunting stand T on his back. The tree hunting stand obscures the rear of the hunter's orange colored jacket reducing the visibility of the hunter and thus increasing the chance that the hunter H may be misidentified as wildlife by other hunter's thus increasing the risk that the hunter may be targeted and shot by other hunters.

The safety cover 20 covers comprises a body 24 made of a hunter orange colored fabric and a plurality of fasteners. The body 24 of the safety cover 20 covers the back 30 and sides 32 of the tree stand T. The surface area of the safety cover body 24 is sufficiently large to cover a substantial portion of a tree stand, backpack or other item carried on the back of the hunter H.

Attached to the body 24 of the safety cover 20 is a securing means for fixing the safety cover 20 in position. In the illustrated embodiment, the securing means comprises ties or straps can be tied to the torso of the hunter or to an object carried on the back of the hunter such as a back pack or a portable tree stand. The ties or straps 22 may be provided with a hook and loop fastening system, buckles, buttons, or other types of fasteners as known in the art.

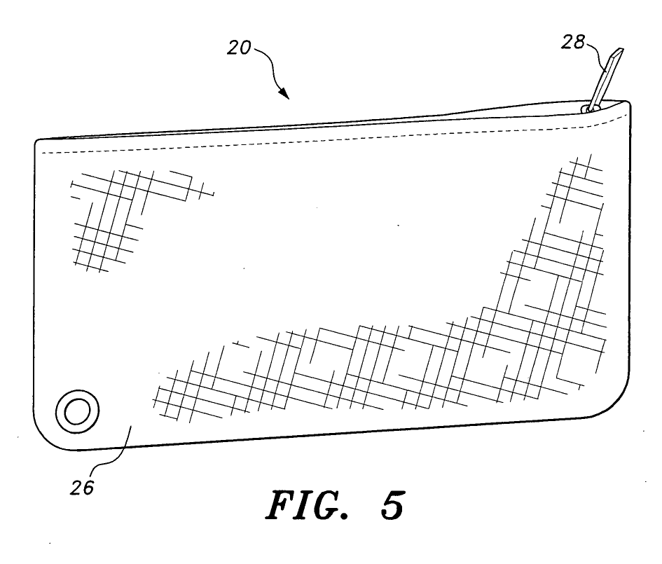

As may be best appreciated by referring to FIGS. 2 and 5, the safety cover 20 includes a storage pouch 26 for holding the safety cover 20 when the safety cover 20 is not in use. The pouch 26 is a closable pocket made of a fabric material. The storage pouch is attached to the body 24 of the safety cover 20. The body 24 of the cover is attached to an interior surface of the pouch 26. The use of an attachment interior point to the pouch 26 allows the entire safety cover 20 to be inserted into the pouch 26 and the pouch to be closed without detaching the pouch from the safety cover 20. The storage pouch 26 is provided with a pouch closing means such as a zipper 28. The pouch closing means may alternatively be any suitable closing mechanism such as a hook and loop fastening system, snaps, buttons with buttonholes, drawstrings, or other mechanism known to one skilled in the art.

The pouch 26 is provided with an eyelet opening 34 that passes through the body of the pouch 26. The eyelet 34 provides a means for securing the pouch when the safety cover is not in use and has been stored in the pouch. The circumference of the eyelet opening 34 may be reinforced with a strong material such as metal. The eyelet provides an attachment point for securing the pouch to a location on the hunter H, the hunter's tree stand T, or to any other convenient location using a hook, a tie, or any other attachment means that can pass through the eyelet 34.

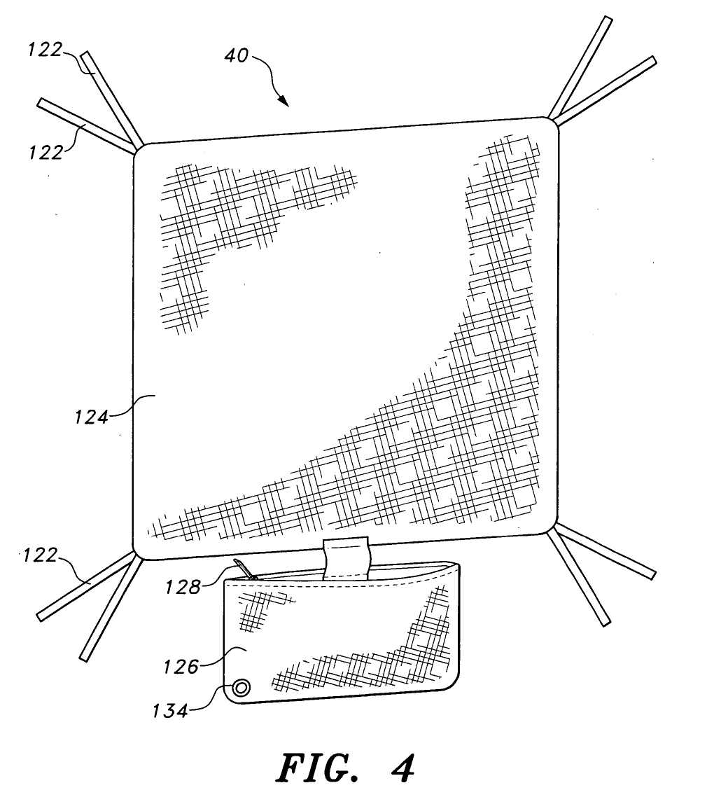

In the embodiment pictured in FIG. 2 the pouch is attached at point near the center of the body of the safety cover. As may be appreciated by referring to FIG. 4, the storage pouch 126 may be attached at various points on the body 124 of a safety cover 40. In the embodiment illustrated in FIG. 4, the pouch 126 is attached to an edge of the body 124 of the safety cover 40, with the attachment point being located on an interior surface of the pouch 126. The pouch 126 includes a fastening means 128, and an eyelet 134 identical to that of the embodiment illustrated in FIGS. 1 and 2. The safety cover 40 is provided with a securing means such as ties 122 that is also identical to the securing means described above for the embodiment of FIGS. 1 and 2.

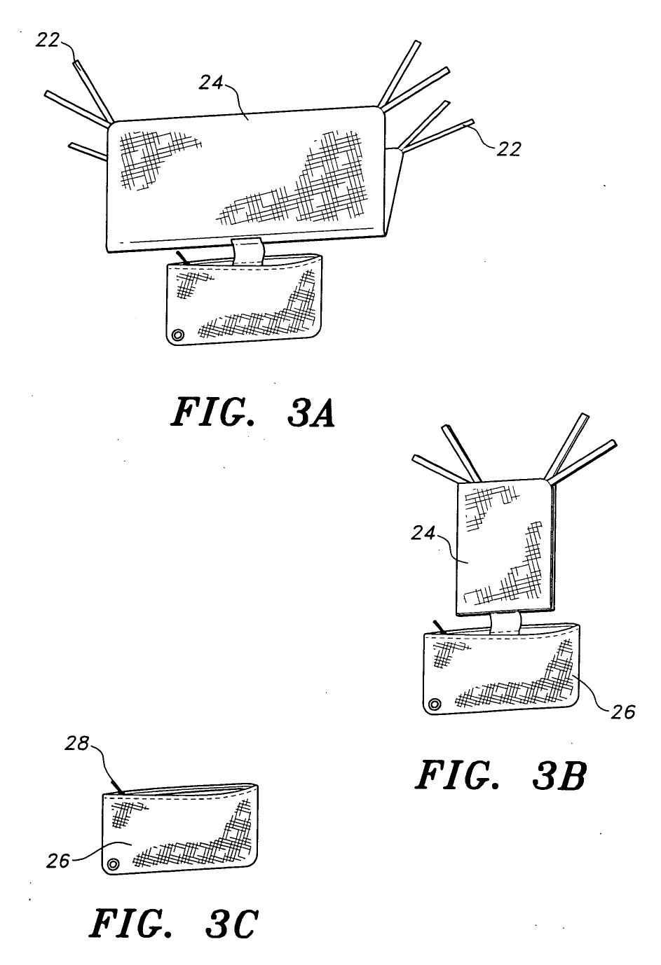

FIGS. 2, 3A, 3B, 3C, and 5 illustrate the use of the attached pouched 26 to store the body of the safety cover. As may be appreciated by referring to FIG. 2, the width and length of the body of the safety cover 20 exceeds the corresponding dimensions of the pouch 26. In FIG. 3A, the body 24 of the safety cover is shown folded along a horizontal line near the attachment point of the pouch resulting in a reduction of the vertical extent of the safety cover body 24. One skilled in the arts would appreciate that continued folding of the material about a horizontal fold line will reduce the vertical extent to a dimension which will fit within the depth of the pouch 26.

As shown in FIG. 3A, by folding each side of the body inwards along vertical fold lines, the horizontal extent of the folded body is reduced to a width that will fit within the horizontal extent or width of the opening of the pouch.

When the folding operations described above are complete, the folded body 24 of the safety cover will fit entirely within the pouch 26 as shown in FIG. 3B. The fastening means of the pouch such as a zipper 28 may then be used to close the pouch as shown in FIG. 5.

The surface area of the safety cover may be chosen to provide a specified effective visible area of signaling color for the hunter. For example the surface area may be chosen for compliance with the minimum required area of a signaling color such as hunters orange as specified by applicable laws or ordinance. In one embodiment of the invention, the body of the safety cover is provides approximately 500 square inches of visible orange surface when worn. In another embodiment, the body of the safety cover may be chosen to comply with a requirement for 400 square inches or 144 square instances of visible signaling color such as hunters orange. In another embodiment, the size of the safety cover may be chosen to compensate for the area of the torso obscured by a trees stand, backpack or other object carried on the hunter's back.

The material of the body of the safety cover may be any foldable material. Preferably the material is durable enough to withstand the hunting environment. Examples of suitable materials include strong fabric materials or flexible plastic sheet materials such as vinyl or nylon.

In the described embodiment, an eyelet in the pouch is provided as a means for mounting the pouch to an object such as the belt of a hunter. The pouch attachment means may alternatively be a lanyard, a clip, a tie fastener or other suitable attachment system.

It is to be understood that the present invention is not limited to the embodiments described above, but encompasses any and all embodiments within the scope of the following claims.

I claim:

1. A tree stand safety cover, comprising:
a covering body of a foldable material adapted for covering gear carried on the back of a hunter;
a storage pouch having an interior pocket, the pocket adapted to hold the folded covering body within the interior pocket, an attachment point on the covering body attached to an interior surface of the pocket;
securing means attached to the covering body adapted to secure the covering body over gear carried on the back of the hunter.

2. The tree stand safety cover according to claim 1, wherein the securing means comprises a plurality of ties.

3. The tree stand safety cover according to claim 1, wherein the securing means comprises a hook and loop fastening system.

4. The tree stand safety cover according to claim 1, wherein the securing means comprises straps with fasteners.

5. The tree stand safety cover according to claim 1, wherein the covering body is of a hunter signaling color.

6. The tree stand safety cover according to claim 5, wherein the hunter signaling color is hunter orange.

7. The tree stand safety cover according to claim 1, wherein the attachment point for the storage pouch is near the perimeter of the covering body.

8. The tree stand safety cover according to claim 1, wherein the attachment point for the storage pocket is near the center of the covering body.

9. The tree stand safety cover according to claim 1, wherein the storage pouch comprises closing means for closing the interior pocket.

10. The tree stand safety cover according to claim 9, wherein the closing means comprises a zipper.

11. The tree stand safety cover according to claim 9, wherein the closing means comprises a hook and loop fastener system.

12. The tree stand safety cover according to claim 1, wherein said storage pouch further comprises attachment means for mounting the pouch.

13. The tree stand safety cover according to claim 1, wherein the pouch attachment means comprises an open eyelet.

14. The tree stand safety cover according to claim 1, wherein the body of the safety cover provides an effective visible area of signaling cover.

15. The tree stand safety cover according to claim 14, wherein the effective visible area of signaling color is approximately five hundred square inches.

16. The tree stand safety cover according to claim 14, wherein the effective visible area of signaling color is at approximately four hundred square inches.

17. The tree stand safety cover according to claim 14, wherein the effective visible area of signaling color is about one hundred forty-four square inches.
